(19) United States
(12) Patent Application Publication
(10) Pub. No.: US 2009/0147388 A1
(43) Pub. Date: Jun. 11, 2009

(54) VEHICLE EXTERIOR REAR-VIEW MIRROR

(75) Inventor: Jose Mendoza, Barcelona (ES)

Correspondence Address: RATNERPRESTIA, P.O. BOX 980, VALLEY FORGE, PA, 19482, US

(73) Assignee: FICO Mirrors, S.A., Barcelona (ES)

(21) Appl. No.: 12/160,834

(22) PCT Filed: Jan. 22, 2007
(86) PCT No.: PCT/IB07/00238

§ 371 Date: Sep. 12, 2008

(30) Foreign Application Priority Data
Jan. 24, 2006 (IB) 2006/000109

(51) Int. Cl. G02B 7/182

(52) U.S. Cl. 359/871

(57) ABSTRACT

The invention relates to a vehicle exterior rear-view mirror including a casing or chassis with a neck to which an adaptor is mated. The adaptor has an abutment surface adapted to abut against a support sheet element associated to an outer panel of the vehicle. The support sheet element has an opening aligned with respective passages of the casing and the adaptor, respectively. A coupling stem is installed through the passages with the possibility of rotation and axial movement. Anchor configurations are formed at a lower end of the stem, the configurations engaging portions of the lower face of the support sheet element adjacent to the opening. An elastic element is arranged between the casing and the stem to push the stem inwards the casing or chassis.

### TECHNICAL FIELD

The present invention generally relates to a vehicle exterior rear-view mirror, and more particularly to an exterior rear-view mirror adapted to be fixed directly to a support sheet element associated to an outer panel of the vehicle.

### STATE OF PRIOR ART

Conventional automotive vehicle exterior rear-view mirrors consist of two units: a first unit comprising a casing or chassis where there is installed at least one mirror with a mechanism for adjusting its orientation; and a second unit comprising a support base adapted to be fixed to an outer panel of the vehicle, for example, by means of screws and internal reinforcement elements. The first unit, i.e. the casing or chassis, includes a removable fixing system for the attachment to the second unit, or support base. This fixing system generally comprises a stem installed through the passage of the casing or chassis and provided at its lower end with configurations adapted to be fixed to complementary configuration formed around an opening of the support base forming a bayonet-type lock. To that end, the stem is assembled such that it can be axially moved and rotated about its axis to a limited extent. Installed around the stem there is a spring compressed to push the stem towards the inside of the casing or chassis, assuring the mentioned bayonet lock.

Patent documents EP-A-1038730, U.S. Pat. No. 6,371,619 and U.S. Pat. No. 6,609,800, of Britax Wingard Ltd., describe a vehicle exterior rear-view mirror made of a single unit adapted to be fixed directly to a vehicle door. For this purpose, the casing or chassis of the mirror has a rotatably coupled foot, inserted in an intermediate cup-shaped member having a lower surface adapted to abut against an outer panel or sheet of the vehicle door. A stem similar to the one described above passes through said foot, through the aforementioned intermediate member and through an opening of the outer panel of the door to be coupled by means of a lock including hooks to an inner frame of the vehicle door, at a more inner level than the outer panel. A spring installed between the foot of the casing or chassis and the stem keeps the intermediate member pressed against the outer sheet of the vehicle. The aforementioned closure includes hook-shaped configurations which are arranged in a circumferential direction at the lower end of the stem and adapted to engage with complementary configurations on the periphery of a hole in said inner frame of the door. Furthermore, the engagement of the hook-shaped configurations of the stem to the complementary configuration of the inner frame, which is carried out by a combined axial and rotational movement of the stem, prevents the rotation of the stem relative to the inner frame. The rotation of the intermediate member in relation to the outer panel is prevented by an irregular contour of the surface of the outer panel where the lower surface of the intermediate member abuts. Stepped configurations to be coupled to complementary configurations formed at the bottom of the intermediate member are formed in the end of the foot in order to provide stable positions of the casing or chassis in relation to the intermediate member.

A drawback for the application of the described rear-view mirror arrangement to a vehicle lies in the fact that in most vehicles, the outer panel is made of a relatively thin sheet which may not be enough to resist a pressure exerted by the intermediate part due to a blow or excessive stress applied to the casing of the rear-view mirror. Thus, with use, the area of the outer panel where the intermediate member abuts can be dented, the fixing of the mirror can be loosened and its position can be altered. Another drawback is that the aforementioned hook-shaped configurations of the lower end of the stem can be released from the coupling with the complementary configuration formed on the periphery of the inner frame of the door, or the latter can be deformed as a result of a torque applied to the mirror assembly. Another drawback is that the intermediate member has to be adapted to the contour of the outer panel of each vehicle model for which it is intended, and must be fixed in its seat on said outer panel or sheet. Apart from that, such intermediate member must conform at its other end, at the upper part, to the configuration of the casing surrounding the mirror, and to allow its rotation as said intermediate member braces the mentioned foot forming a whole with such casing. This last requirement significantly conditions the viability of the proposal set forth in the prior art document referred to. Furthermore, the aforementioned stepped configurations at the bottom of the cup constituting the intermediate member are difficult to shape and their manufacture is not cost-effective. The use of an auxiliary sheet or inner panel 34 as shown in FIGS. 2, 4 and 5 of the mentioned patent EP-A-1038730, in which a mounting hole for anchoring the stem is defined, has the same aforementioned drawbacks since the connection of the mirror to the vehicle depends on the coupling of the mentioned engagement configurations in the stem with the mentioned complementary configurations in the periphery of the hole, in this case made in an auxiliary sheet or panel.

### DISCLOSURE OF THE INVENTION

An object of the present invention is contributing to overcome the previous and other drawbacks by providing a vehicle exterior rear-view mirror constructed as a single unit and adapted to be fixed to a support sheet element, such as a reinforcement sheet associated to an outer panel of the vehicle but without the intervention of this outer panel of the vehicle. For this purpose, the vehicle exterior rear-view mirror of the present invention comprises a casing or chassis, an adaptor, a coupling stem and a spring, which can be supplied mutually coupled in a pre-installation condition as a single unit ready to be fixed to the mentioned reinforcing sheet element, which may have been previously incorporated to an outer panel of a door or another body section of the vehicle by the manufacturer of said door or body section.

The term “outer panel” intends to cover any element in the form of a sheet of those generally used in the automotive sector to form the “skin” of the vehicle, either a steel sheet or a sheet of another metal, such as aluminium for example, or a rigid sheet made of a plastic material, such as polyester resin reinforced with glass fiber for example.

The aforementioned casing or chassis has a neck through which a first passage is arranged, and said adaptor is mated to this neck of the casing or chassis. The adaptor comprises a second passage aligned with said first passage of the casing or chassis and an abutment surface adapted to abut against the reinforcing sheet element associated to an outer panel of the vehicle. The reinforcing sheet element has an opening aligned with said first and second passages. The aforementioned coupling stem is adapted to be installed through the first passage of the neck and through the second passage of the adaptor, with the possibility of axial movement. The coupling stem has a first end where there is formed at least one anchor configuration extending radially outwards. This first end of the coupling stem and said anchor configuration are adapted to pass through the aforementioned opening of the reinforcing sheet element. The coupling stem further has a ring-shaped flange joined close to a second end thereof. A compressed spring is arranged between said ring-shaped flange joined to the stem and said casing or chassis to push the coupling stem towards the inside of the casing or chassis.

When the mirror is fixed to the reinforcing sheet element with the coupling stem in a predetermined orientation in relation to the opening thereof, at least one portion of the reinforcing sheet element located on the periphery of the opening is trapped between said abutment surface of the adaptor and said at least one anchor configuration of the coupling stem due to the force of said spring, thus preventing the extraction of the coupling stem from the opening of the reinforcing sheet element.

The adaptor further comprises at least one first positioning configuration adapted to be engaged with at least one second coupling configuration of said reinforcing sheet element to ensure a correct positioning of said adaptor in relation to the opening of the reinforcing sheet element, and first retaining configurations adapted to cooperate with second retaining configurations of the coupling stem to immobilize the coupling stem in relation to the adaptor, and thus immobilize the coupling stem in said predetermined orientation in relation to the opening of the reinforcing sheet element.

In one exemplary embodiment, the aforementioned ring-shaped flange joined to the coupling stem is formed as separate limiting part having an inner thread adapted to be coupled to an outer thread formed in at least one portion close to said second end of the coupling stem. This threaded attachment can facilitate the assembly of the casing or chassis, the adaptor, the coupling stem and the spring into said pre-installation condition, and especially offers the possibility of easily disassembling the fixing of the rear-view mirror unit by removing the limiting part from the stem. For this purpose, the limiting part has gripping configurations adapted to receive the coupling of a disassembly tool introduced through a space of the casing or chassis communicated with the first passage, and a lid or another element of the casing or chassis for example, can be removed to provide an easy access to said space.

With this construction, the vehicle exterior rear-view mirror of the present invention has a number of advantages. Firstly, the fixing of the rear-view mirror assembly does not transmit any force to the outer panel of the vehicle, because such fixing is carried out on a reinforcing sheet element designed to resist the required stresses. Secondly, the mirror can be supplied as a single unit in a pre-installation condition, which involves less manufacturing and management costs given that the number of parts and units forming it is smaller, and less installing costs given that only one operation or a reduced number of operations is necessary for fixing it to the vehicle, compared to the mirrors known in prior art. On the other hand, the ease in the disassembly contributes to reducing the costs for repairing or replacing an already installed mirror and provides a greater safety for the operator compared to the mirrors of the prior art.

### BRIEF DESCRIPTION OF THE DRAWINGS

The above and other advantages and features will be more fully understood from the following detailed description of exemplary embodiments with reference to the attached drawings in which:

FIGS. 1A and 1B show perspective views illustrating two examples of prior art rear-view mirrors constructed in two units for the fixing to the vehicle;

FIG. 2 shows a partially sectioned partial view of a prior art rear-view mirror constructed as a single unit adapted to be fixed to the vehicle;

FIG. 3 shows an exploded perspective view of a vehicle exterior rear-view mirror according to an exemplary embodiment of the present invention adapted to be fixed to a reinforcing sheet element of the vehicle;

FIG. 4 is a perspective view of the rear-view mirror of FIG. 3 assembled and fixed to the reinforcing sheet element of the vehicle;

FIG. 5 is a perspective view showing an alternative construction for the coupling stem of the assembly of FIG. 1;

FIG. 6 is an enlarged upper perspective view of the adaptor of FIG. 1;

FIG. 7 is a partial enlarged upper perspective view showing a first end of the coupling stem of FIG. 1 or of FIG. 5;

FIG. 8 is an enlarged upper perspective view of the reinforcing sheet element of FIG. 1;

FIG. 9 is a partial, enlarged lower perspective view showing the first end of the coupling stem arranged to be coupled to the adaptor;

FIG. 10 is an enlarged lower perspective view showing the first end of the coupling stem coupled to the adaptor;

FIG. 11 is a partial cross-sectional view of the rear-view mirror unit of FIG. 1 in a pre-installation condition in relation to the reinforcing sheet element in an outer panel of a vehicle;

FIG. 12 is a partial cross-sectional view of the rear-view mirror unit once it has been fixed to the reinforcing sheet element in the outer panel of the vehicle;

FIG. 13 is a partially sectioned side view, with an enlarged detail, showing a first installation example in which the reinforcing sheet element where the rear-view mirror unit is fixed is located next to a lower portion of a window frame in a vehicle door;

FIG. 14 shows a partially sectioned side view, with an enlarged detail, showing a second installation example in which the reinforcing sheet element where the rear-view mirror unit is fixed is located in a lower front corner of a window frame in a vehicle door;

FIG. 15 is a partial exploded perspective view illustrating a detail of the first installation example of FIG. 13;

FIG. 16 is an exploded perspective view of a coupling stem and an adaptor forming part of a vehicle exterior rear-view mirror according to another embodiment of the present invention;

FIGS. 17 to 20 are partial perspective views showing a sequence of operations for assembling the coupling stem and the adaptor of FIG. 16 in a pre-installation condition;

FIGS. 21 and 22 are diagrammatic illustrations partially showing a planar development of the adaptor of FIGS. 16 to 20 seen from the inner passage thereof, with the projections of the coupling stem in a pre-installation preparation position and in a pre-installation condition, respectively; and

FIGS. 23 and 24 are diagrammatic illustrations similar to those of FIGS. 21 and 22 but with the adaptor coupled to the reinforcing sheet element and the projections of the coupling stem in the pre-installation condition and in an installed situation, respectively; and

FIG. 25 is a partial perspective view showing the vehicle exterior rear-view mirror according to the exemplary embodiment including the coupling stem and the adaptor of FIGS. 16 to 20 in said pre-installation condition.

### DETAILED DESCRIPTION OF EXEMPLARY EMBODIMENTS

The terms “up” and “down”, “upper” and “lower” and their derivatives are used throughout this description in relation to the positions in which the elements of the rear-view mirrors are shown in the Figures, these positions being, on the other hand, the most usual ones in the actual assembly of a rear-view mirror in a vehicle.

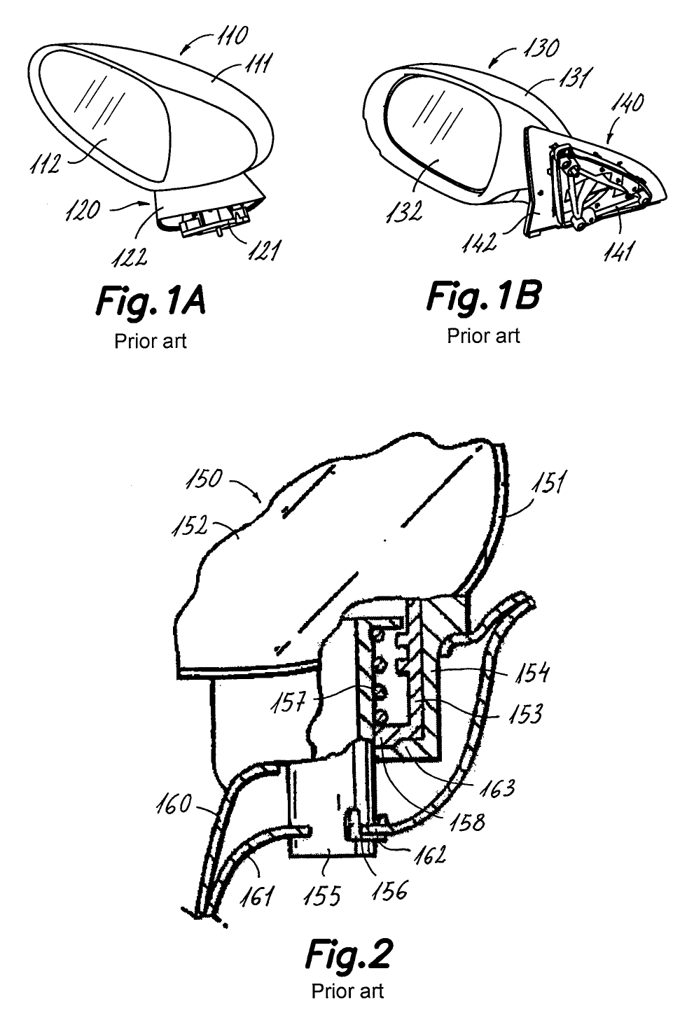

Several examples of vehicle exterior rear-view mirrors of the prior art are first described in relation to FIGS. 1A, 1B and 2.

The mirror shown in FIG. 1A is constructed as two units 110 and 120 which are supplied as completely separate units, although they are shown as mutually coupled in FIG. 1A. The aforementioned first unit 110 comprises a casing or chassis 111 where at least one mirror 112 is installed, usually including a manually- or motor-driven mechanism (not shown), adapted to adjust the orientation of the mirror. The second unit 120 comprises a support base 121 adapted to be fixed to an outer panel of the vehicle (not shown) by means of fastening elements, such as for example screws passed through holes of the outer panel and secured to reinforcement elements arranged at the inner side of the outer panel. The second unit 120 usually includes a decorative trim 122 the function of which is to cover the support base 121 and eventually press a gasket (not shown) against the outer panel of the vehicle surrounding the screws or the support base 121.

The first unit 110 includes a removable fixing system (not shown) for the attachment to the second unit 120. This fixing system is conventional and is generally based on a stem installed through the passage of the casing or chassis and provided at its lower end with configurations adapted to be fixed to complementary configuration formed around an opening formed at an upper part of the support base, constituting a bayonet-type lock. The construction of the prior art example shown in FIG. 1A is suitable for assembling the rear-view mirror next to a lower portion of a vehicle door window frame or on a vehicle mudguard, for example.

The mirror shown in FIG. 1B is also constructed as two units 130 and 140 which are supplied as completely separate units, although they are shown as mutually coupled in FIG. 1B. In a manner similar to that described in relation to FIG. 1A, the aforementioned first unit 130 comprises a casing or chassis 131 where at least one mirror 132 is installed, usually with an adjustment mechanism. The second unit 140 comprises a support base 141 adapted to be fixed to an outer panel of the vehicle (not shown) by means of fastening elements, such as screws for example. The second unit 140 here also exceeding a predetermined torque to overcome the force of the spring 157 is applied on the casing or chassis 151.

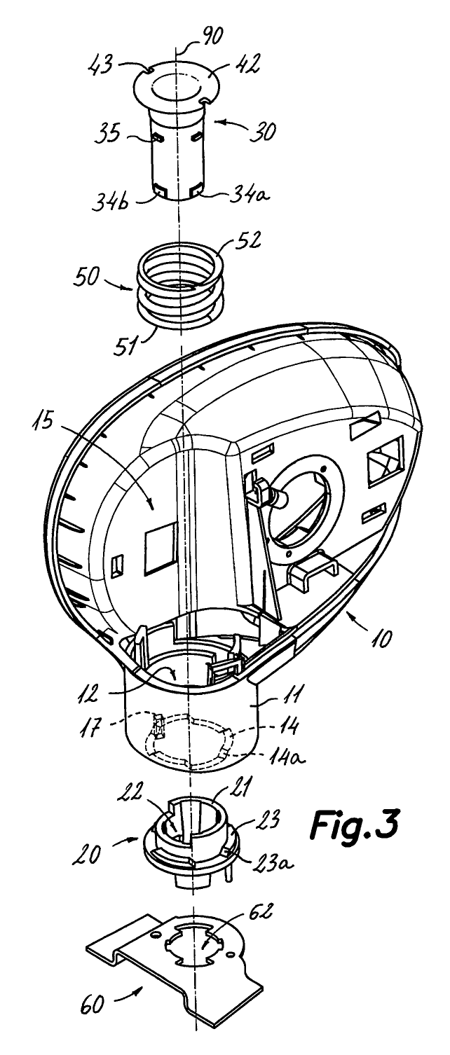

With reference now to FIG. 3, a vehicle exterior rear-view mirror according to an exemplary embodiment of the present invention is described, which is designed to be supplied as a single unit essentially comprising a casing or chassis 10, an adaptor 20, a coupling stem 30 and an elastic element, in the form of a spring 50 for example. The aforementioned casing or chassis 10 carries, or is adapted to carry at least one mirror (not shown) and eventually a mechanism (not shown) for adjusting the position of said mirror. As described in detail below, the aforementioned mirror unit is adapted to be fixed to a reinforcing sheet element 60 associated to an outer panel of the vehicle, which does not form part of the rear-view mirror unit although it is adapted thereto.

The casing or chassis 10 has a neck 11 through which a first passage 12 is defined. The casing or chassis 10 has a space 15 formed in communication with said first passage 12 for the purpose of provide an easy access thereto. The aforementioned adaptor 20 comprises a second passage 22 aligned with the first passage 12 of the casing or chassis 10, and a cylindrical wall 21 surrounding said second passage 22. The adaptor 20, an upper view of which is shown with more details in FIG. 6, is mated to the neck 11 of the casing or chassis 10, with said cylindrical wall inserted in the first passage 12 thereof, acting as a guide for the rotation of the adaptor 20 in relation to the casing or chassis 10. Such performance allows a single adaptor to be used for different mirrors provided with particular configurations of both their neck 11, and their casing 10 to which such neck 11 is attached generally forming a one-piece body. In other words, the neck 11 can have any outer shape provided that its inner passage 12 has a suitable diameter to receive the insertion of the cylindrical wall 21 of the adaptor.

The cylindrical wall 21 of the adaptor 20 has a cut-out defining first and second limits 29a, 29b adapted to cooperate with an inner stop 17 (shown by means of dashed lines in FIG. 3) extending from a wall of the first passage 12 towards the inside thereof to limit the rotation of the casing or chassis 10 in relation to the adaptor 20. The neck 11 of the casing or chassis 10 has first coupling configurations 14 formed around a first end of the first passage 12, and the adaptor 20 has second coupling configurations 23 formed around the cylindrical wall 21. The aforementioned first and second coupling configurations 14, 23 are respectively complementary and are in the form of planar surfaces that are stepped in the circumferential direction, with inclines transition surfaces 14a, 23a between them. The first and second coupling configurations 14, 23 are thus adapted to be mutually coupled when the casing or chassis 10 is in a predetermined orientation in relation to the adaptor 20, and to allow a rotation of the casing or chassis 10 in relation to the adaptor 20 with an axial usually includes a decorative trim 142 the function of which is to cover the support base 141 and possibly press a gasket (not shown) against the outer panel of the vehicle. The first unit 130 includes a removable fixing system (not shown), equivalent to that of the previous example, based on a bayonet-type lock for the attachment to the second unit 140. The construction of the example of the state of the art shown in FIG. 1B is suitable for assembling the mirror in a lower front corner of a window frame in a vehicle door, for example.

The mirror partially shown in FIG. 2 corresponds to that described in patents EP-A-1038730, U.S. Pat. No. 6,371,619 and U.S. Pat. No. 6,609,800, of Britax Wingard Ltd., cited above, which is constructed as a single unit 150 comprising a casing or chassis 151 where at least one mirror 152 is installed, usually with the inclusion of an adjustment mechanism. The casing or chassis 151 includes a foot 153 having a central passage, and it is arranged inside an intermediate member 154, such that said foot 153 is rotatably coupled to said fixed intermediate member. The aforementioned intermediate member 154 has a lower surface adapted to abut against an outer panel 160 of the vehicle door and an upper surface which must conform to the particular configuration of the casing surrounding the mirror, which requires different intermediate members if this solution is to be applied to different rear-view mirrors. A coupling stem 155 is passed through the foot 153, through a passage of the intermediate member 154 and through an opening of the outer panel 160 of the door to be coupled, by means of respective complementary coupling configurations 156, 162, to an inner frame 161 of the door.

The aforementioned coupling configurations 156 of the coupling stem 155 are hook-shaped and are adapted to be engaged with the coupling configurations 162 of the inner frame 161 by a combined movement of axial displacement and rotation of the coupling stem 155. A spring 157 installed between the foot 153 of the casing or chassis 151 and the coupling stem 155 pushes the coupling stem 155 towards the inside of the casing or chassis 151 and this keeps the coupling configurations 156 of the stem engaged with the coupling configurations 162 of the inner frame 161 and the intermediate member 154 pressed against the outer panel 160 of the vehicle. The engagement of the coupling configurations 156 of the stem with the coupling configurations 162 of the inner frame 161 prevents the rotation of the coupling stem 155 in relation to the inner frame 161, and the abutment of the inner surface of the intermediate member 154 against the outer panel 160 of the vehicle door, which has an irregular contour, prevents the rotation of the intermediate member 154 in relation to the outer panel 160.

In a conventional manner, complementary stepped configurations 158, 159, formed respectively in the foot 153 of the casing or chassis 151 and in the intermediate member 154, prevent the rotation of the casing or chassis 151 in relation to the intermediate member 154 unless a force movement of the casing or chassis 10 forced by the interaction of the aforementioned inclined transition surfaces 14a, 23a. The mentioned coupling configurations 14 can be formed in the body itself of the neck 11 or on a reinforcement part.

The adaptor 20, the lower part of which is shown with more details in FIGS. 9 and 10, has at its lower part an abutment surface 24 adapted to abut against the aforementioned reinforcing sheet element 60 associated to an outer panel 70 of the vehicle. Although it is not essential, this abutment surface 24 as well as the upper surface of the reinforcing sheet element 60 is advantageously planar. The reinforcing sheet element 60 has an opening 62 which can be aligned with said first and second passages 12, 22 of the casing or chassis 10 and of the adaptor 20, respectively. A pair of first positioning configurations 25a, 25b extends downwards from the abutment surface 24 of the adaptor 20. Said positioning configurations are adapted to couple with second complementary coupling configurations 61a, 61b formed in said reinforcing sheet element 60. In the illustrated embodiment, the mentioned first positioning configurations 25a, 25b are in the form of substantially cylindrical first and second pins having different diameters extending in the axial direction, and the second coupling configurations 61a, 61b are in the form of first and second holes with diameters complementary to the diameters of the first positioning configurations 25a, 25b. The first and second pins 25a, 25b are thus configured and arranged to be fit in the corresponding first and second holes 61a, 61b when the adaptor 20 is in a predetermined orientation in relation to the reinforcing sheet element 60 for the purpose of ensuring a correct and univocal positioning of said adaptor 20 in relation to the opening 62 of the reinforcing sheet element 60. A person skilled in the art will be able to achieve an equivalent effect with two first and two second coupling configurations with different shapes and/or arranged in different positions than those shown in the Figures, or with a single first and a single second coupling configuration, or with more than two first and two second coupling configurations.

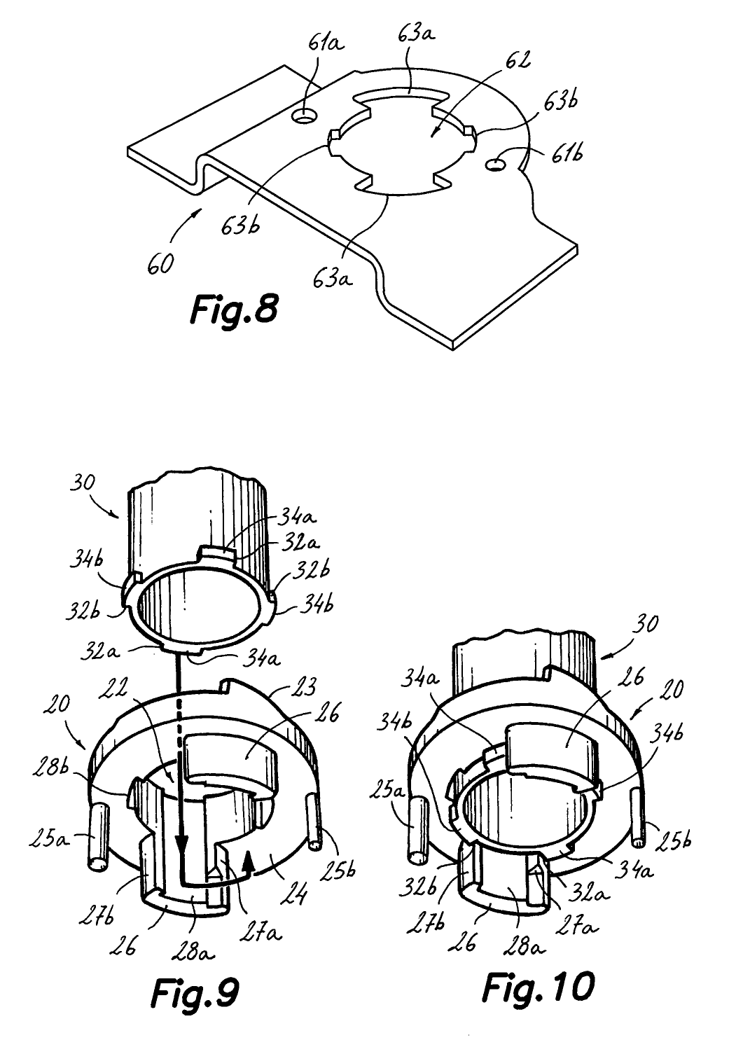

The adaptor 20 further comprises at its lower part two pairs of first retaining configurations 27a, 27b the function of which will be described in detail below. Each pair of first retaining configurations 27a, 27b is connected by a respective connection wall 26 forming two constructions like diametrically opposed merlons. The reinforcing sheet element 60, shown in detail in FIG. 8, comprises two first notches 63a formed in a peripheral edge of said aperture 62 adapted to allow passage of the two pairs of first retaining configurations 27a, 27b of the adaptor 20 and its respective connecting walls 26 therethrough. Also here the number of pairs of first retaining configurations 27a, 27b and corresponding notches 63a is irrelevant, at least one pair being enough.

The rear-view mirror unit of the present invention also comprises a coupling stem 30 adapted to be installed through the first passage 12 of the neck 11 of the casing or chassis 10 and the second passage 22 of the adaptor 20 with the possibility of axial movement and rotation. The mentioned coupling stem 30 has a first end (or lower end, shown in greater detail in FIGS. 7, 9 and 10) where two pairs of first and second projections 34a, 34b are formed radially extending outwards alternately at equal angular distances. Each one of said first and second projections 34a, 34b defines an anchor configuration 31 in the form of an upper surface substantially perpendicular to a centerline 90 of the coupling stem 30 (FIG. 7). In the first and second projections 34a, 34b are also formed two pairs of second retaining configurations 32a, 32b. One of said second retaining configurations of each pair is formed in each one of the first projections 43a, having the form of a first surface 32a substantially parallel to said centerline 90, whereas the other of the second retaining configurations of each pair is formed in each one of the second projections 43b, having the form of a second surface 32b substantially parallel to said centerline 90 (FIGS. 7 and 9). The first and second surfaces 32a, 32b of each pair are facing each other in a circumferential direction and adapted to respectively cooperate with the mentioned two pairs of first retaining configurations 27a, 27b of the adaptor 20 in a manner explained in detail below. Obviously, the number of pairs of second retaining configurations 32a, 32b of the coupling stem 30 will be in accordance with the number of pairs of first retaining configurations 27a, 27b of the adaptor 20, although at least one pair would be enough.

The adaptor 20 comprises two pairs of first and second grooves 28a, 28b extending axially along the inner surface of the second passage 22. These first and second grooves 28a, 28b are configured to allow the passage of the aforementioned first and second projections 34a, 34b of the coupling stem 30 therealong for the purpose of allowing the lower end of the coupling stem 30 to pass through the second passage 22 of the coupling 20. Each of the aforementioned first grooves 28a is located such that it has a portion in one of the connecting walls 26 between the corresponding retaining configurations 27a, 27b, and the second grooves 28b are arranged at 90° between the first grooves 28a.

The reinforcing sheet element 60 comprises two second notches 63b formed in said peripheral edge of the opening 62 between the first notches 63a (FIG. 8). These second notches 63b are adapted to allow the passage therethrough of the second projections 34b of the coupling stem 30, whereas the first projections 34a, together with the walls 26 and the corresponding first and second stops 27a, 27b of the adaptor 20, pass through the first notches 63a. For the purposes of the present invention, also here a single pair of first and second notches 63a, 63b would be enough, although the number thereof will agree with the number of pairs of first and second retaining configurations 27a, 27b; 32a, 32b.

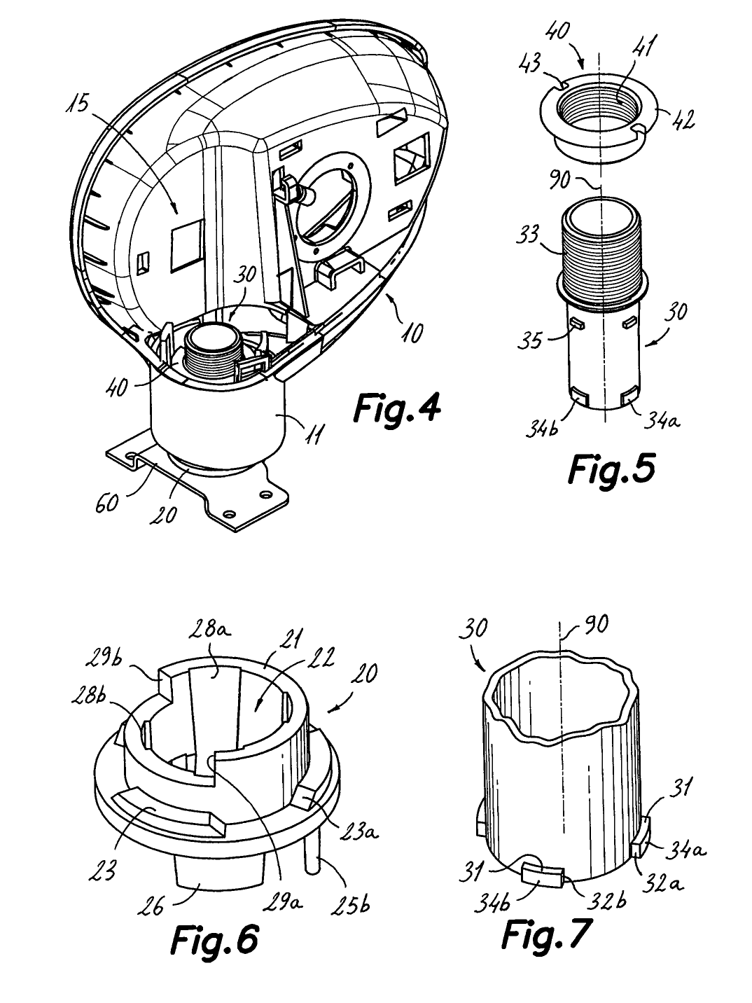

The aforementioned spring 50 is installed between a projection in the form of a ring-shaped flange 42 joined to the stem 30 and the casing or chassis 10, said spring 50 being compressed to push the coupling stem 30 towards the inside of the casing or chassis 10. More particularly, the aforementioned spring 50 is a coil spring and is arranged around the coupling stem 30. The neck 11 of the casing or chassis 10 has a first seat 13 formed around a second end, or upper end, of the first passage 12 to receive and resist a first end 51 of the spring 50, whereas the aforementioned ring-shaped flange 42 joined to the coupling stem 30 forms a second seat adapted to resist a second end 52 of the spring 50. The ring-shaped flange 42 can be conventionally formed integral with the coupling stem 30, as shown in FIG. 3, although a novel construction of the coupling stem 30 in two parts is preferred, like the one shown in FIG. 5, where the coupling stem 30 has an outer thread 33 formed at least in one portion close to its second end, or upper end, and the ring-shaped flange 42 is formed in a limiting member 40 having formed thereon an inner thread 41 adapted to be coupled to said outer thread 33 of the coupling stem 30. The limiting member 40 further comprises gripping configurations 43 adapted to receive the coupling of a disassembly tool (not shown) introduced through the aforementioned space 15 (FIGS. 3 and 4) of the casing or chassis 10 in communication with the first passage 12. It is thus possible to separate the casing or chassis 10 from the reinforcing sheet element 60 in a relatively comfortable manner from a rear part of the rear-view mirror. In the embodiment shown in FIGS. 3 and 4, this rear part of the casing or chassis 10 is adapted to receive a detachable protective cover (not shown).

The operation of the fixing system for fixing the rear-view mirror unit to the reinforcing sheet element 60 is described with reference to FIGS. 9 to 12. It must be taken into account that the reinforcing sheet element 60 has been omitted in FIGS. 9 and 10 for the sake of greater clarity in the drawing.

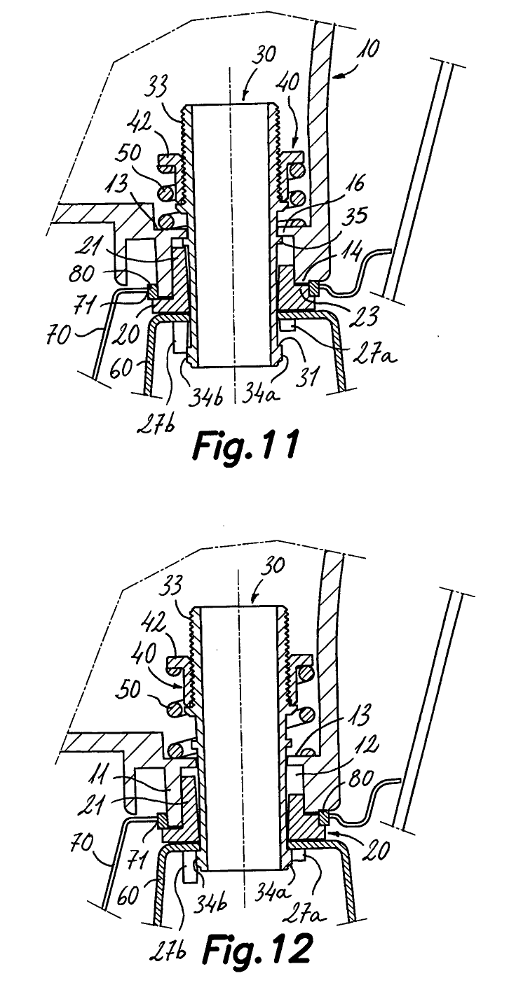

As shown in FIGS. 9 and 10, each pair of first retaining configurations 27a, 27b of the adaptor 20 is shaped to provide first and second stops 27a, 27b projects downwards from the abutment surface 24, next to second passage 22. The distance in the circumferential direction between opposite surfaces of these first and second stops 27a, 27b is equal to the distance in the circumferential direction between the aforementioned first and second surfaces 32a, 32b forming the second retaining configurations formed at the lower end of the coupling stem 30. In each pair of first retaining configurations of the adaptor 20, the first stop 27a is shorter in the axial direction than the second stop 27b. Thus, when the neck 11 of the casing or chassis 10 is mated with the adaptor 20 and the latter is coupled to the reinforcing sheet element 60, the coupling stem 30 can be inserted through the first passage 12 of the casing or chassis 10, through the second passage 22 of the adaptor 20 and through the opening 62 of the reinforcing sheet element 60 and axially moved outwards the casing or chassis 10 thus compressing the spring 50 until the first and second projections 34a, 34b project from a lower side of the reinforcing sheet element 60. The projecting axial distance is enough for the first projection 34a to exceed the extension of the first stop 27a of the adaptor 20 (FIG. 11). The size of the wall 26 in the axial direction is equal to the size of the second stop 27b in the axial direction.

The coupling stem 30 can then be rotated in a first direction so that the first projection 34a of the coupling stem 30 inserted through the first groove 28a can leave the first groove 28a sideways passing under the lower end of the first stop 27a, as indicated by means of an arrow in FIG. 9. The axial length of the second stop 27b is suitable for preventing the rotation of the coupling stem 30 in a second direction opposite to said first direction. The aforementioned rotation in the first direction hits a limit when the second surface 32b of the second projection 34b of the coupling stem 30 makes contact with the second stop 27b of the adaptor 20, which occurs when the coupling stem 30 is in a predetermined orientation in relation to the adaptor 20 and at the same time that the first surface 32a of the first projection 34a has exceeded the first stop 27a in the circumferential direction. The coupling stem 30 can be then axially moved again towards the inside of the casing or chassis 10 in favor of the spring 50 until the anchor configurations 31 formed in the first and second projections 34a, 34b of the coupling stem 30 make contact with the lower face of the reinforcing sheet element 60 (not shown in FIG. 10). Several portions of the reinforcing sheet element 60 located on the periphery of the opening 62 are thus trapped between the abutment surface 24 of the adaptor 20 and said anchor configurations 31 of the coupling stem 30 due to the force of said spring 50 (FIG. 12), which prevents the extraction of the coupling stem 30 from the opening 62 of the reinforcing sheet element 60 while the coupling stem 30 is in said predetermined orientation in relation to the opening 62 of the reinforcing sheet element 60. In this situation (FIG. 10), the first and second stops 27a, 27b of the adaptor 20 are placed between the first and second surfaces 32a, 32b of the first and second projections 34a, 34b of the coupling stem 30, thus immobilizing the rotation of the coupling stem 30 in relation to the adaptor 20 to prevent the accidental release of the coupling.

With specific reference to FIGS. 11 and 12, in order to facilitate the installation of the rear-view mirror unit, the neck 11 of the casing or chassis 10 comprises one or more first pre-installation retaining configurations 16 projecting radially towards the inside of the first passage 12, and the coupling stem 30 comprises one or more second pre-installation retaining configurations 35 (see also FIGS. 3 and 5) projecting radially outwards. As shown in FIG. 11, the aforementioned first pre-installation retaining configurations 16 of the casing or chassis 10 are adapted to be coupled to said second pre-installation retaining configurations 35 of the coupling stem 30 when the coupling stem 30 is at a pre-installation axial position and orientation in relation to the casing or chassis 10. In this pre-installation axial position and orientation, the coupling stem 30 is displaced outwards from the casing or chassis 10, the spring 50 is compressed, and the surfaces 31 of the first projections 34a of the coupling stem 30 project from the abutment surface 24 of the adaptor 20 a distance that is enough to pass under the first stop 27a of the adaptor 20. The first pre-installation retaining configurations 16 of the casing or chassis 10 are adapted to be disengaged from said second pre-installation retaining configurations 35 of the coupling stem 30 when the coupling stem 30 is rotated to said predetermined orientation in relation to the adaptor 20. The rear-view mirror unit can be assembled, stored and supplied in this pre-installation condition.

The rear-view mirror unit thus prepared is installed in the vehicle in the following manner. The lower end of the coupling stem 30 is first passed through the opening 62 of the reinforcing sheet element 60, and the first and second pins 25a, 25b of the adaptor are inserted in the corresponding first and second holes 61a, 61b of the reinforcing sheet element 60 until the abutment surface 24 of the adaptor 20 abuts against the upper face of the reinforcing sheet element 60 (FIG. 11). The coupling stem 30 is then rotated in the first direction to the predetermined orientation, whereby the second pre-installation retaining configurations 35 of the coupling stem 30 come out of the coupling with the first pre-installation retaining configurations 16 of the casing or chassis 10 and the force of the spring 50 pushes the coupling stem 30 towards the inside of the casing or chassis 10 until the anchor configurations 31 of the coupling stem 30 are applied against the lower face of the reinforcing sheet element 60 (FIG. 12). The rear-view mirror unit is thus fixed to the reinforcing sheet element 60 previously incorporated in the vehicle.

When the rear-view mirror unit is installed, the adaptor 20 is in the predetermined orientation in relation to the reinforcing sheet element 60, and the casing or chassis 10 is in the predetermined orientation in relation to the adaptor 20. Only in the event that an external force that is greater than a predetermined value is applied to the casing or chassis 10, the casing or chassis 10 can rotate in relation to the adaptor 20 with a small simultaneous movement in the axial direction against the force of the spring 50 by virtue of the aforementioned inclined transition surfaces 14a, 23a (FIG. 3) existing between the first and second coupling configurations 14, 23 of the neck 11 of the casing or chassis 10 and of the adaptor 20, respectively.

FIGS. 11 and 12 show that the aforementioned outer panel 70 of the vehicle has an opening 71 opposite to the opening 62 of the reinforcing sheet element 60. The adaptor 20 can thus access the reinforcing sheet element 60 through said opening 71 of the outer panel 70 of the vehicle. The reinforcing sheet element 60 is preferably at a lower level, or in an inner position in relation to the outer panel 70 of the vehicle, such that the adaptor 20 is at least partially sunk with respect to the outer panel 70 of the vehicle. A ring-shaped gasket 80 is arranged in order to seal a gap existing between a peripheral edge of said opening 71 of the outer panel 70 of the vehicle and a perimetric area of the neck 11 of the casing or chassis 10 and/or of the adaptor 20.

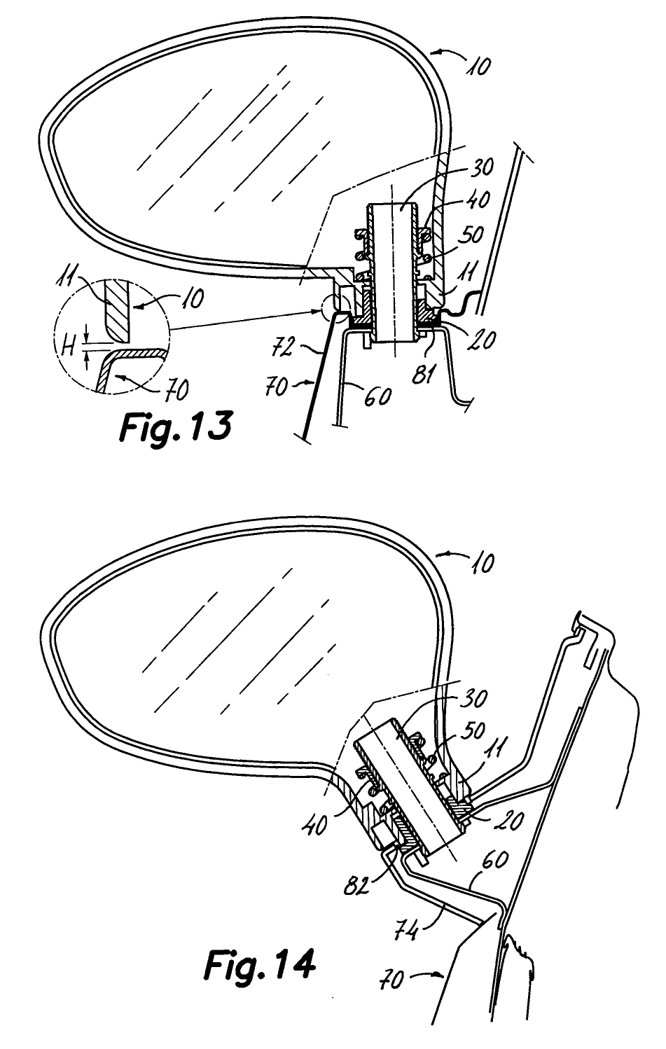

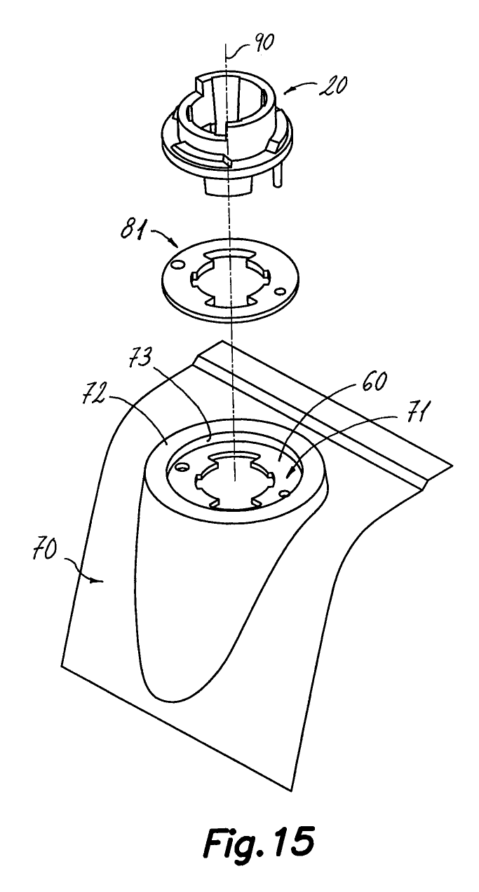

FIG. 13 shows a first installation example of the rear-view mirror unit in which the reinforcing sheet element 60 is located in a lower portion of a vehicle door window frame. In this case, the neck 11 of the casing or chassis 10 extends downwards in a substantially vertical direction. As better shown in FIG. 15, a configuration 72 defining an enlarged area around the opening 71 is formed in the outer panel 70 of the vehicle. This configuration 72 has an inner wall 73 surrounding the opening 71 and has a lower edge very close to or making contact with the upper face of the reinforcing sheet element 60. Eventually, there may be some welding points between said lower edge of the inner wall 73 of the outer panel 70 of the vehicle and the reinforcing sheet element 60, which have a different thickness. The inner wall 73 and the reinforcing sheet element 60 together define a housing in which the gasket 81 is arranged, the gasket 81 being, in this case, in the form of a disk with an opening and holes coinciding with the opening 62 and the holes 61a, 61b of the reinforcing sheet element 60. Once the rear-view mirror unit is installed, the gasket 81 is trapped between the abutment surface 24 of the adaptor 20 and the reinforcing sheet element 60. A sideways expansion of the elastic material of the gasket 81 caused by the compression in the axial direction makes the peripheral area of the gasket 81 be pressed against the inner wall 73, sealing the gap between the peripheral edge of the opening 71 of the outer panel 70 of the vehicle and the adaptor 20. The configuration 72 can have, if appropriate, a shape conjugated with the shape of the neck 11 of the casing or chassis 10. The configuration 72 can alternatively form part of a detachable part, for example a plastic cover fixed to the outer panel of the vehicle 70 by suitable fixing means, such as elastic tabs. It will be appreciated in the installation example shown in FIGS. 11 to 13, that there is a gap H (see the enlarged detail of FIG. 13) between the casing or chassis 10 of the mirror and the outer panel 70 of the vehicle, therefore the mirror does not transmit any stress to the outer panel 70.

In the second installation example shown in FIG. 14, the reinforcing sheet element 60 is located in a front lower corner of a window frame in a vehicle door. In this case, the neck 11 of the casing or chassis 10 extends downwards in an inclined direction towards the vehicle door. The reinforcing sheet element 60 extends outwards in relation to the outer panel 70 of the vehicle and is covered by a plastic cover 74 fixed to the outer panel 70 or to the vehicle window frame. Also here is it not possible for any effort on the mirror to be transmitted to the outer panel 70. The plastic cover 74 has an opening facing the opening 62 of the reinforcing sheet element 60 and the neck 11 of the casing or chassis 10 is adapted to be placed facing an area of the plastic cover 74 around its opening. To seal a gap existing between a peripheral edge of the opening in the plastic cover 74 of the vehicle and a perimetric area of the neck 11 of the casing or chassis 10 and/or of the adaptor 20 there is arranged a ring-shaped gasket 82, similar to the one described above in relation to FIGS. 11 and 12. The plastic cover 74 can have a shape conjugated with the shape of the neck 11 of the casing or chassis 10.

The mentioned gaskets 80, 81 and 82 could have a substantially common configuration able to conform to different installation configurations or arrangements explained.

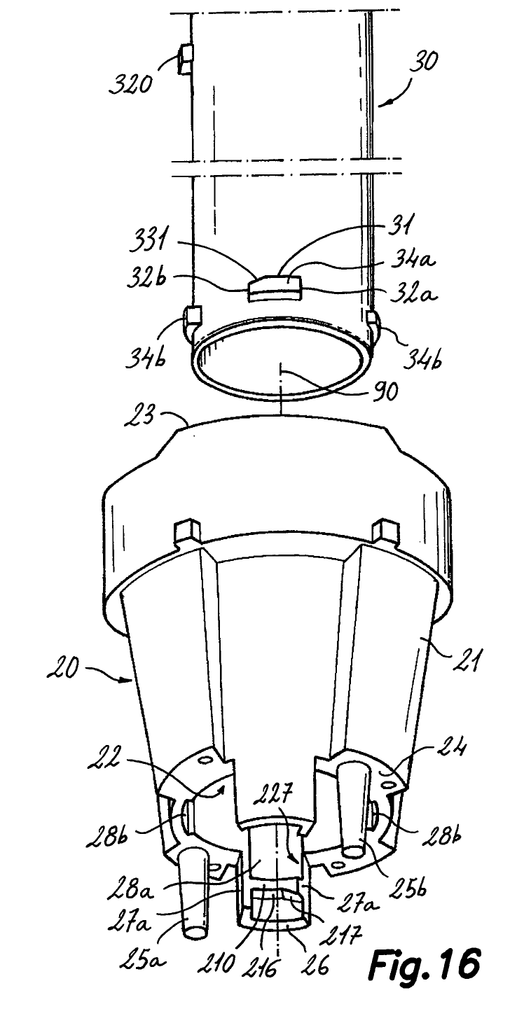

Another exemplary embodiment of the vehicle exterior rear-view mirror of the present invention is described below in reference to FIGS. 16 to 25, this embodiment being based on the same principle as the exemplary embodiment described above but differing therefrom in the means for arranging the mirror in a pre-installation condition. In both exemplary embodiments the same reference numbers are used to designate identical or equivalent features.

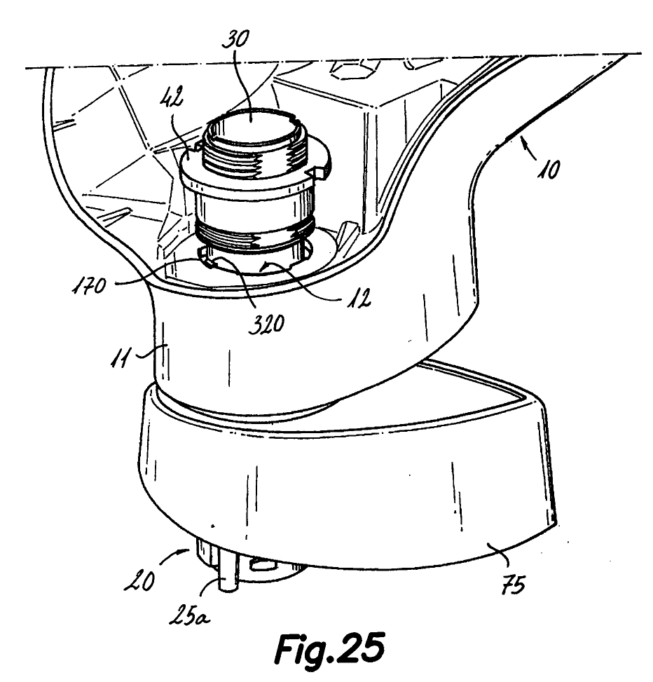

FIG. 16 shows a coupling stem 30 and an adaptor 20. In a similar way to that described above in relation to the first embodiment shown in FIGS. 5, 6, 7, 9 and 10, the adaptor 20 of this second embodiment comprises a surrounding wall 21 surrounding a second passage 22 adapted to be aligned with a first passage 12 of a casing or chassis 10 (partially shown in FIG. 25). A pair of connecting walls 26 project from an abutment surface 24 formed at a lower end of the adaptor 20, each connecting wall 26 forming a nexus between a first stop 27a and a second stop 27b. Two pairs of first and second grooves 28a, 28b are formed on an inner surface of said second passage 22 for the passage of corresponding pairs of first and second projections 34a, 34b formed at the end of the coupling stem 30. The first grooves 28a of the adaptor 20 are located between the first and second stops and extend in part of the connecting walls 26. Each of the first and second projections 34a, 34b defines an anchor configuration 31 in the form of an upper surface 31 substantially perpendicular to a centerline 90 of the coupling stem 30 and a pair of second retaining configurations 32a, 32b in the form of first and second side surfaces 32a, 32b parallel to said centerline 90. The first and second stops 27a, 27b with the connecting walls 26 of the adaptor 20 and the end of the coupling stem 30 with the first and second projections 34a, 34b are adapted to pass through an opening 62 of a reinforcing sheet element 60 similar to the one described above in relation to FIG. 8, and the first and second projections 34a, 34b of the coupling stem 30 are adapted to engage a region of the edge of said opening 62 in a similar manner as in the first embodiment.

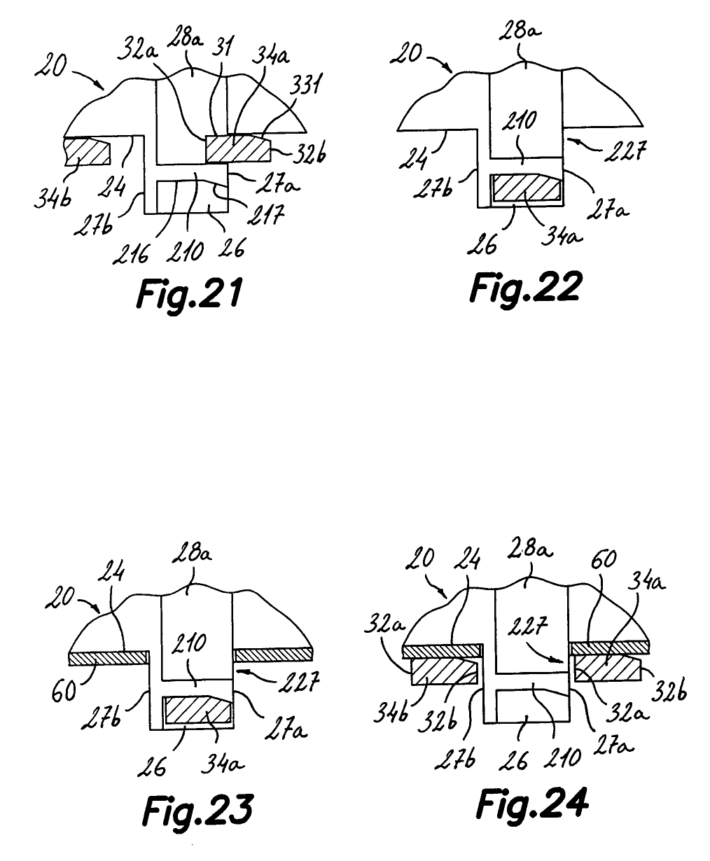

Unlike the first embodiment, here a ledge 210 projects radially inwards from each connecting wall 26, interrupting the first groove 28a, and the first stop 27a is formed at one end, in the circumferential direction, of said ledge 210, such that between an upper surface of said ledge 210 and the abutment surface 24 a passage 227 communicating with the first groove 28a is formed in the circumferential direction above of the first stop 27a. The distance apart in the axial direction from the upper surface of the ledge 210 to the abutment surface 24 is slightly greater than the thickness in the axial direction of the first projection 34a of the coupling stem 30, such that the first projection 34a inserted in the first groove 28a can come out of first groove 28a through the aforementioned passage 227 by means of a rotation of the coupling stem 30, as it is shown in FIGS. 18 and 21. Then, once the first projection 34a is out of the first groove 28a, and by means of several operations that will be explained in detail below, the coupling stem 30 can be placed in relation to the adaptor 20 in a pre-installation condition shown in FIGS. 20 and 22, in which the first projection 34a rests on the ledge 210, keeping the stem compressed.

The ledge 210 has a lower surface defining a pre-installation retaining configuration 216 adapted to engage the aforementioned surface 31 of the first projection 34a of the coupling stem 30 when the coupling stem 30 is in a pre-installation condition in relation to the adaptor 20. In this pre-installation condition, the coupling stem 30 is in a pre-installation axial position and orientation in relation to the casing or chassis 10 and to the adaptor 20 such that the first projection 34a rests against the ledge 210 and a spring 50 similar to the one described above in relation to FIG. 3 is compressed between a ring-shaped flange 42 joined to the stem 30 and the casing or chassis 10. Furthermore, in the pre-installation condition the first and second projections 34a, 34b of the coupling stem 30 are aligned with the first and second grooves 28a, 28b of the adaptor, facilitating the insertion of the adaptor 20 and the coupling stem 30 in the opening 62 of the reinforcing sheet element 60 when the rear-view mirror unit is in the pre-installation condition shown in FIG. 22.

FIG. 23 shows the adaptor 20 inserted, together with the stem 30 carrying the first and second projections 34a, 34b in the pre-installation condition, in the opening 62 of the reinforcing sheet element 60. In this position, the abutment surface 24 makes contact with a surface of the reinforcing sheet element 60. It will be seen that the thickness of the reinforcing sheet element 60 partially closes the aforementioned passage 227 thereby preventing passage therethrough of the first projection 34a when the coupling stem 30 has been placed in the installed position shown in FIG. 24, in which the first and second projections 34a, 34b press against the reinforcing sheet element 60 and the rotation of the coupling stem 30 is prevented or limited by the interference of the retaining configurations 32a, 32b of the projections 34a, 34b of the coupling stem 30 with the first and second stops 27a, 27b provided in the connecting wall 26 of the adaptor 20. This occurs because the aforementioned distance apart in the axial direction from the upper surface of the ledge 210 to the abutment surface 24 is less than the sum of the thicknesses of the first projection 34a of the coupling stem 30 and the reinforcing sheet element 60.

It can be seen in FIG. 24 that in this second embodiment there is a clearance between the retaining configurations 32a, 32b of the projections 34a, 34b of the coupling stem 30 and the first and second stops 27a, 27b of the adaptor 20. This clearance may have a variable amplitude as deemed appropriate, and it may be small enough to substantially immobilize the rotation of the coupling stem 30 in relation to the adaptor.

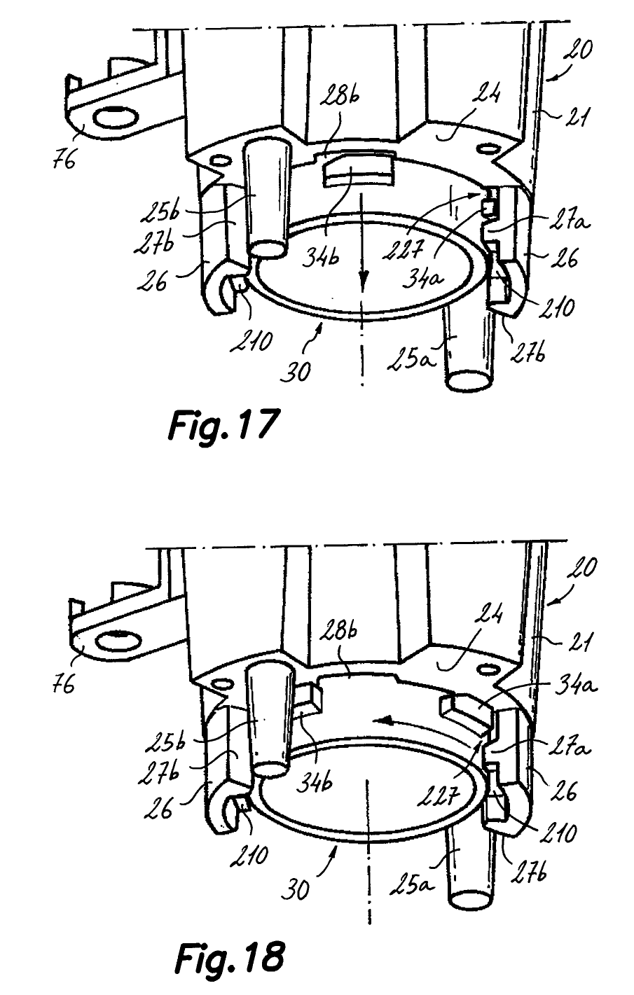

A sequence of operations suitable to arrange the coupling stem 30 in said pre-installation condition in relation to the adaptor 20 is additionally show in FIGS. 17 to 20. It can be seen that by virtue of the aforementioned distance apart in the axial direction between the ledge 210 and the abutment surface 24, the coupling stem 30 can only be arranged in the pre-installation condition when the adaptor 20 and the coupling stem 30 are not inserted in the opening 62 of the reinforcing sheet element 60.

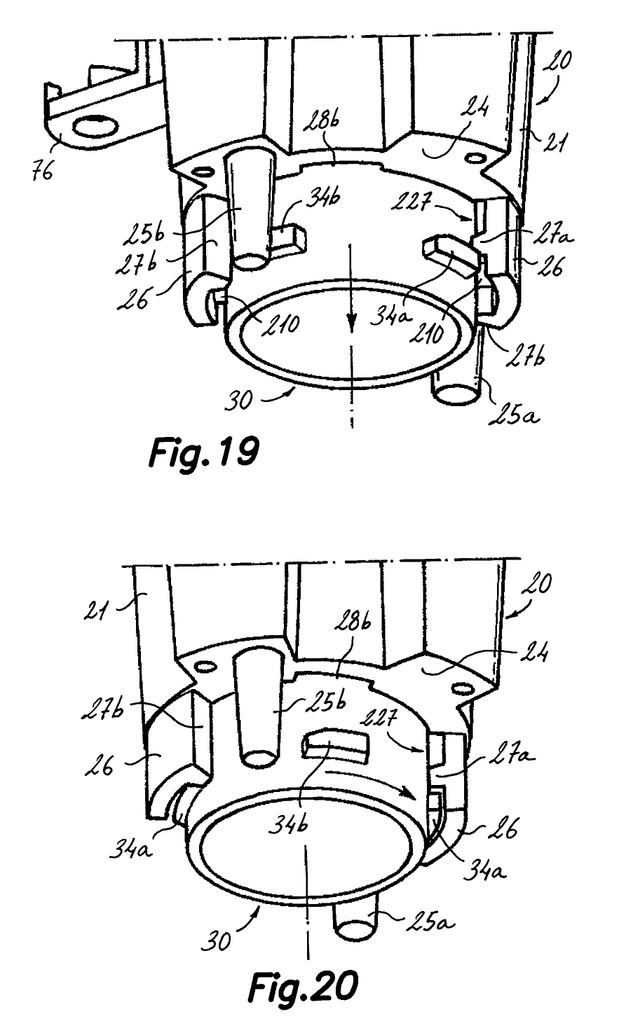

As shown in FIG. 17, the first step of the sequence comprises axially moving the coupling stem 30 outwards the casing or chassis 10 against the force of the spring 50 until the first and second projections 34a have exceeded the abutment surface 24. Then, as shown in FIG. 18, the coupling stem 30 must be rotated in a first direction to make the first projections 34a come out of the first grooves 28a passing through the aforementioned passage 227 between the ledges 210 and the abutment surface 24 until the first projections 34a have exceeded the corresponding first stops 27a in the circumferential direction. Then, as shown in FIG. 19, the coupling stem is axially moved outwards the casing or chassis 10 against the force of the spring 50 until the first projections 34a have exceeded the corresponding first stops 27a in the axial direction. Finally, and as shown in FIG. 20, the sequence comprises rotating the coupling stem 30 in a second direction, opposite to said first direction, until the surfaces 31 of the first projections 34a are facing said pre-installation retaining configurations 216 of the ledges 210, and from this position releasing the coupling stem 30 so that the force of the spring 50 pushes the coupling stem 30 axially inwards the casing or chassis 10 until the surfaces 31 of the first projections 34a are retained and pressed against the corresponding preinstallation retaining configurations 216 of the ledges 210.

To ensure a stable position of each first projection 34a on its corresponding ledge 210, and therefore a stable position of the rear-view mirror unit in the pre-installation condition, the pre-installation retaining configuration 216 of the ledge 210 defines a surface substantially perpendicular to the centerline 90 of the coupling stem 30 connecting with an outwardly and downwardly inclined ramp portion 217 adjacent to the first stop 27a (FIGS. 16 and 21). Complementarily, the surface 31 of the anchor configuration of the first projection 34a of the coupling stem 30 has a bevel edge 331 formed thereon adapted to be mated with said ramp portion 217 when the surface 31 of the first projection 34a of the coupling stem 30 is engaged with the pre-installation retaining configuration 216 of the ledge 210, thereby contributing to preventing the first projections 34a from accidentally coming out of the ledges 210.

As in the first embodiment, the vehicle exterior rear-view mirror unit according to this second embodiment can be supplied in the aforementioned preinstallation condition and the reinforcing sheet element 60 can be incorporated to the vehicle. To install the rear-view mirror unit it is enough to insert the first and second stops 27a, 27b and the connecting walls 26 of the adaptor 20 and the end of the coupling stem 30 with the first and second projections 34a, 34b through the opening 62 of the reinforcing sheet element 60 when the rear-view mirror unit is in the pre-installation condition. Once the abutment surface 24 of the adaptor 20 is in contact with the reinforcing sheet element 60, a rotation of the coupling stem 30 in the first direction with respect to the adaptor 20 moves the first projections 34a out of the ledges 210 and the force of the spring 50 moves the coupling stem 30 towards the inside of the casing or chassis 10 until the anchor configurations formed by the surfaces 31 of the first and second projections 34a, 34b press against the side of the reinforcing sheet element 60 opposite to the abutment surface 24 of the adaptor, thus fastening the rear-view mirror unit to the reinforcing sheet element 60 in an installed position.

In this installed position (shown in FIG. 24 for this second embodiment), the thickness of the reinforcing sheet element 60 placed between the abutment surface 24 of the adaptor 20 and the first and second projections 34a, 34b of the coupling stem 30 causes that the first projections 34a cannot pass through the passage 227 existing between the ledge 210 and the abutment surface 24 of the adaptor, thereby the retaining configurations formed by the first side surfaces 32a of the first projections 34a of the coupling stem 30 remain facing to and possibly interfering with the first stops 27a of the adaptor 20 while at the same time the retaining configurations formed by the second side surfaces 32a of the second projections 34a of the coupling stem 30 are facing and possibly interfering with the second stops 27b of the adaptor 20, thus preventing or limiting the possibility of rotation of the coupling stem 30 in relation to the adaptor 20.

As shown in FIG. 25, this second embodiment further incorporates means to facilitate the rotation of the coupling stem 30 in relation to the adaptor 20 for the purpose of releasing the rear-view mirror unit from the pre-installation condition. The coupling stem 30 comprises to this end a drive configuration 320 (also shown in FIG. 16) located in a position away from the first end where the first and second projections 34a, 34b are located. The aforementioned drive configuration 320 projects outwards from the coupling stem 30 and is adapted to be inserted in a drive channel 170 formed in the first passage 12 of the neck 11 of the casing or chassis 10 when the rear-view mirror unit is in said pre-installation condition. The aforementioned drive channel 170 is adapted to drive the drive configuration 320 when the casing or chassis 10 is rotated in relation to the adaptor 20, and thereby rotating the coupling stem 30 until disengaging the surface 31 of the first projection 34a of the coupling stem 30 from the pre-installation retaining configuration 216 of the ledge 210 of the adaptor 20, thereby the rear-view mirror unit changing from the pre-installation condition to an installed position.

The adaptor 20 of this second embodiment is preferably configured to access the reinforcing sheet element 60 through an opening of an outer panel of the vehicle, opposite to the opening 62 of the reinforcing sheet element 60. The adaptor 20 will generally be sunk at least in part in relation to the outer panel of the vehicle, and the adaptor 20 has a surrounding overlay 75 fixed thereto having a shape conjugated with the shape of the neck 11 of the casing or chassis 10 and with an area of the outer panel around said opening. The aforementioned surrounding overlay 75 is fixed to the adaptor 20 by means of a support 76 joined to the latter (FIGS. 17 to 19). The rear-view mirror unit can optionally be supplied such that the aforementioned pre-installation condition coincides with a folded position, or parking position, of the casing or chassis 10 in relation to the adaptor 20 and the surrounding overlay 75 fixed thereto, as shown in FIG. 25. The rear-view mirror unit would thus change from the pre-installation condition to the installed situation by rotating the casing or chassis 10 from the folded or parking position to a use position.

The drive configuration 320 of the coupling stem 30 is adapted to come out of the drive channel 170 of the casing or chassis 10 as a result of the movement of the coupling stem 30 in the axial direction inwards the casing or chassis 10 caused by the force of the spring 50 when the surface 31 of the first projection 34a of the coupling stem 30 comes out of the pre-installation retaining configuration 216 of the ledge 210 of the adaptor 20, changing from the pre-installation situation to the installed situation. Therefore, once the rear-view mirror unit is coupled to the reinforcing sheet element 60 in the installed situation, the casing or chassis 10 can be freely changed between the use position and the folded or parking position without this affecting the fixing of the unit to the vehicle.

A person skilled in the art will be able to introduce variations and modifications in the shown and described embodiments without departing from the scope of the present invention as defined in the attached claims.

1. A vehicle exterior rear-view mirror, comprising:
a casing or chassis having a neck with a first passage;
an adaptor mated to said neck of the casing or chassis, said adaptor comprising a second passage maligned with said first passage of the casing or chassis and an abutment surface adapted to abut against a support sheet element of the vehicle, an opening of said support sheet element being aligned with said first and second passages;
a coupling stem adapted to be installed through the first passage of the neck and of the second passage of the adaptor with the possibility of rotation and axial movement, said coupling stem having a first end with at least one anchor configuration extending radially outwards, said first end of the coupling stem and said anchor configuration being adapted to pass through said opening of the support sheet element; and
an elastic element arranged between a projection attached to or integral with the coupling stem and said casing or chassis to push the coupling stem towards the inside of the casing or chassis,
wherein at least one portion of the support sheet element located on the periphery of the opening is trapped between said abutment surface of the adaptor and said at least one anchor configuration of the coupling stem by the force of said elastic element, thereby preventing an extraction of the coupling stem from the opening of the support sheet element when the coupling stem is in at least one predetermined orientation in relation to the opening,
the adaptor further comprising:
at least one first positioning configuration adapted to be coupled to at least one second coupling configuration of said support sheet element to prevent or limit the rotation of said adaptor in relation to the support sheet element; and
first retaining configurations adapted to cooperate with second retaining configurations of the coupling stem to prevent or limit the rotation of the coupling stem in relation to the adaptor, thereby preventing or limiting the rotation of the coupling stem with respect to said predetermined orientation in relation to the support sheet element.

2. (canceled)

3. A rear-view mirror according to claim 1, wherein said first retaining configurations of the adaptor are in the form of first and second stops projecting downwards from said abutment surface next to the second passage, and said projections of the coupling system include at least one pair of first and second projections defining said anchor configurations in the form of coplanar surfaces substantially Perpendicular to a centerline of the coupling stem and said second retaining configurations in the form of first and second surfaces substantially parallel to said centerline, said first and second surfaces of the second retaining configurations facing one another in a circumferential direction, and a distance between opposite surfaces in the circumferential direction of said first and second stops being substantially equal to a distance in the circumferential direction between said first and second surfaces of the second retaining configurations of the coupling stem.

4.-5. (canceled)

6. A rear-view mirror according to claim 1, wherein the adaptor comprises at least first and second grooves extending axially along an inner surface of the second passage, said first and second grooves being configured to allow the passage of the first and second projections of the coupling stem through the second passage, the first groove being located between said first and second stops.

7. A rear-view mirror according to claim 40, wherein a ledge intercepting the first groove is located between the first and second stops, and a passage communicating with the first groove in the circumferential direction is provided between the first stop and the abutment surface, a distance in the axial direction from the first stop to the abutment surface being slightly greater than the thickness in the axial direction of the first projection of the coupling stem and less than the sum of thicknesses in the axial direction of the first projection of the coupling stem and the support sheet element.

8. A rear-view mirror according to claim 7, wherein said ledge defines a pre-installation retaining configuration adapted to engage the surface of the first projection of the coupling stem in a pre-installation condition in which the coupling stem is in a pre-installation axial position and orientation in relation to the adaptor, and the first and second projections of the coupling stem are aligned with the first and second grooves of the adaptor, respectively.

9. A rear-view mirror according to claim 8, wherein said pre-installation retaining configuration of the ledge comprises a lower surface substantially perpendicular to the centerline of the coupling stem to engage the surface of the first projection of the coupling stem, and a projecting ramp portion adjacent to the first stop to mate with a bevel edge formed on the surface of the first projection of the coupling stem when the surface of the first projection of the coupling stem is engaged with the pre-installation retaining configuration of the ledger.

10. A rear-view mirror according to claim 9, wherein the coupling stem comprises a drive configuration projecting radially outwards in a position away from its first end, and adapted to be inserted in a drive channel formed in the first passage of the neck of the casing or chassis in said pre-installation condition, said drive channel being adapted to drive said drive configuration and thereby to rotate the coupling stem until disengaging the surface of the first projection of the coupling stem from the pre-installation retaining configuration of the ledge when the adaptor and the coupling stem are inserted in the opening of the support sheet element and the casing or chassis is rotated in relation to the adaptor from the pre-installation condition to an installed position.

11. A rear-view mirror according to claim 10, wherein the drive configuration of the coupling stem is adapted to come out of the drive channel of the casing or chassis as a result of a movement of the coupling stem in the axial direction towards the inside of the casing or chassis caused by the force of the elastic element when the surface of the first projection of the coupling stem comes out of the pre-installation retaining configuration of the ledge of the adaptor.

12. A rear-view mirror according to claim 40, wherein the first stop has a length in the axial direction from the abutment surface that is suitable for allowing, when the adaptor is inserted in the opening of the support sheet element and the coupling stem is inserted through the second passage of the adaptor, the coupling stem to be axially moved outwards the casing or chassis against the force of the elastic element, rotated in a first direction to make the first projection of the coupling stem come out of the first groove and pass in the circumferential direction under the first stop, and then axially moved towards the inside of the casing or chassis by the force of the elastic element until the surfaces of the anchor configurations of the first and second projections of the coupling stem make contact with said portions of the support sheet element located on the periphery of the opening, thereby the first and second stops are placed between the first and second surfaces of the first and second projections of the coupling stem, thus immobilizing the rotation of the coupling stem in relation to the adaptor and fixing the adaptor and the coupling stem to the support sheet element.

13. (canceled)

14. A rear-view mirror according to claim 12, wherein the second stop has a length in the axial direction from the abutment surface that is suitable for preventing the rotation of the coupling stem in a second direction opposite to said first direction when the first projection of the coupling stem is in an axial position that is suitable for passing under the first stop.

15. A rear-view mirror according to claim 14, wherein the neck of the casing or chassis comprises at least one first pre-installation retaining configuration projecting radially towards the inside of the first passage configured to engage a second pre-installation retaining configuration projecting radially outwards from the coupling stem when the coupling stem is in a pre-installation axial position and orientation in relation to the casing or chassis in which the anchor configuration of the first projection of the coupling stem projects from the abutment surface of the adaptor at a sufficient distance in the axial direction to pass under the first stop of the adaptor, the engagement of said first and second pre-installation retaining configurations retaining the coupling stem is in said pre-installation axial position and orientation in relation to the casing or chassis against the force of the elastic element, the first pre-installation retaining configuration of the casing or chassis being configured to be disengaged from said second pre-installation retaining configuration of the coupling stem by rotating the coupling stem to said predetermined orientation in relation to the adaptor.

16.-17. (canceled)

18. A rear-view mirror according to claim 1, wherein said first positioning configuration of the adapter is in the form of at least one pin extending axially from the abutment surface, and the support sheet element comprises said second coupling configuration in the form of at least one hole, said pin being configured and arranged to fit into said hole when the adaptor is in an predetermined orientation in relation to the support sheet element.

19. A rear-view mirror according to claim 1, wherein the adaptor comprises two of said first positioning configurations in the form of first and second pins extending axially from the abutment surface, said first and second pins being configured and arranged to fit into corresponding first and second holes formed in the support sheet element when the adaptor is in a predetermined orientation in relation to the support sheet element, said first and second holes constituting two of said second positioning configurations of the reinforcing sheet element.

20. A rear-view mirror according to claim 1, wherein the neck of the casing or chassis has first coupling configurations formed around a first end of the first passage, and the adaptor has second coupling configurations formed around a surrounding wall surrounding the second passage, said first and second coupling configurations being adapted to be mutually coupled when the casing or chassis is in a predetermined orientation in relation to the adaptor, and to allow a rotation of the casing or chassis in relation to the adaptor forcing axial movement of the casing or chassis against the force of the elastic element when an external rotational force exceeding a predetermined value is applied to the casing or chassis.

21. A rear-view mirror according to claim 1, wherein said elastic element is a compressed coil spring placed around the coupling stem, and the neck of the casing or chassis comprises a first seat around a second end of the first passage adapted to resist a first end of the coil spring, said projection from the coupling stem forming a second seat adapted to resist a second end of the coil spring.

22. A rear-view mirror according to claim 21, wherein the projection is in the form of a ring-shaped flange formed in a limiting member having an inner thread adapted to be coupled to an outer thread formed in at least one portion close to a second end of the coupling stem, said ring-shaped flange comprising a gripping configurations adapted to receive the coupling of a tool introduced through a space of the casing or chassis in communication with the first passage.

23. (canceled)

24. A rear-view mirror according to claim 1, wherein the adaptor comprises a wall connecting said first and second stops.

25. A rear-view mirror according to claim 41, wherein said surrounding wall surrounding the second passage of the adaptor has a cut-out defining first and second limits adapted to cooperate with an inner stop extending towards the inside of the first passage from the neck of the casing or chassis to limit the rotation of the casing or chassis in relation to the adaptor.

26.-39. (canceled)

40. A rear-view mirror according to claim 6, wherein said first and second stops of the adaptor and the first projection of the coupling stem placed between them are configured to pass through a first notch formed in a peripheral edge of said opening of the support sheet element, and the second projection of the coupling stem is configured to pass through a second notch formed in said peripheral edge of the opening of the support sheet element.

41. A rear-view mirror according to claim 20, wherein said surrounding wall surrounding the second passage of the adaptor is configured to be mated by insertion with the possibility of rotation inside the first passage of the neck of the chassis or casing.

42. A rear-view mirror according to claim 40, wherein the adaptor comprises two groups of diametrically opposite stops, each formed by a pair of said first and second stops with a connecting wall therebetween, two of said first grooves diametrically opposite and extending along the connecting walls, and two of said second grooves diametrically opposite; the coupling stem comprises two groups of said first and second projections diametrically opposite; and the support sheet element comprises two of said first notches, diametrically opposite, and two of said second notches, diametrically opposite, formed in the peripheral edge of the opening.
